(19) United States
(12) Patent Application Publication
(10) Pub. No.: US 2015/0168543 A1
(43) Pub. Date: Jun. 18, 2015

(54) POSITIONING SYSTEM RANGING MEASUREMENT

(71) Applicant: QUALCOMM Incorporated, San Diego, CA (US)

(72) Inventors: Bin Tian, San Diego, CA (US); Ahmad Jalali, Rancho Santa Fe, CA (US)

(73) Assignee: QUALCOMM Incorporated, San Diego, CA (US)

(21) Appl. No.: 14/106,447

(22) Filed: Dec. 13, 2013

(51) Int. Cl. G01S 11/02

(52) U.S. Cl. CPC G01S 11/02

(57) ABSTRACT

A method in accordance with an aspect of the present disclosure includes receiving a first ranging signal from an asset tag. The method also includes receiving a second ranging signal that was transmitted a known delay after the first ranging signal. The second ranging signal is from another device. Such a method further includes computing a pseudo-range between a point of reception and the asset tag based at least in part on a time difference between the first ranging signal and the second ranging signal.

### FIELD

Aspects of the present disclosure relate generally to wireless communication systems, and more particularly to a position location architecture.

### BACKGROUND

Wireless networks are widely deployed to provide various communication services such as voice, video, packet data, messaging, broadcasting and other like wireless communication services. These wireless networks may be multiple-access networks capable of supporting multiple users by sharing the available network resources. In a wireless local area network (WLAN), an access point supports communication for a number of wireless stations within the wireless network. In an ad-hoc mode, the wireless stations (“peer nodes”) communicate in a peer-to-peer (P2P) manner without an access point. Similarly, a peer-to-peer network allows the peer nodes to directly communicate with one another. In a peer-to-peer network, peer-to-peer nodes within range of one another discover and communicate directly without an access point.

A positioning system may refer to a network of devices used to wirelessly locate objects or people, for example inside a building. Instead of using a satellite positioning system (SPS), a positioning system may rely on nearby nodes that actively locate tags.

### SUMMARY

An aspect of the present disclosure describes a method within a position location system including receiving a first ranging signal from an asset tag. The method also includes receiving, from another device, a second ranging signal that was transmitted a known delay after the first ranging signal. Such a method further includes computing a pseudo-range between a point of reception and the asset tag based on a time difference between the first ranging signal and the second ranging signal.

A position location apparatus in accordance with one or more aspects of the present disclosure includes a memory and at least one processor coupled to the memory. The processor(s) is configured to receive a first ranging signal from an asset tag. The processor(s) is also configured to receive, from another device, a second ranging signal that was transmitted a known delay after the first ranging signal. The processor(s) is further configured to compute a pseudo-range between a point of reception and the asset tag based on a time difference between the first ranging signal and the second ranging signal.

Another position location system in accordance with one or more aspects of the present disclosure includes means for receiving a first ranging signal from an asset tag and means for receiving a second ranging signal, from another device, that was transmitted a known delay after the first ranging signal. Such a system further includes means for computing a pseudo-range between a point of reception and the asset tag based on a time difference between the first ranging signal and the second ranging signal.

A computer program product for position location in accordance with one or more aspects of the present disclosure includes a non-transitory computer-readable medium having non-transitory program code recorded thereon. The program code includes program code to receive a first ranging signal from an asset tag. The program code further includes program code to receive, from another device, a second ranging signal that was transmitted a known delay after the first ranging signal. The program code further includes program code to compute a pseudo-range between a point of reception and the asset tag based on a time difference between the first ranging signal and the second ranging signal.

A method within a position location system in accordance with one or more aspects of the present disclosure includes sending a first ranging signal from a first asset tag. Such a method further includes receiving, at the first asset tag, a second ranging signal that was transmitted from a device a known delay after the first ranging signal was received. Such a method also includes computing, at the first asset tag, a pseudo-range between the first asset tag and the device based on a time difference between sending the first ranging signal and receiving the second ranging signal.

A position location apparatus in accordance with one or more aspects of the present disclosure includes a memory and at least one processor coupled to the memory. The processor(s) is configured to send a first ranging signal from a first asset tag. The processor(s) is further configured to receive, at the first asset tag, a second ranging signal that was transmitted from a device a known delay after the first ranging signal was received. The processor(s) is also configured to compute, at the first asset tag, a pseudo-range between the first asset tag and the device based on a time difference between sending the first ranging signal and receiving the second ranging signal.

Another position location apparatus in accordance with one or more aspects of the present disclosure includes means for sending a first ranging signal from a first asset tag. Such a system further includes means for receiving, at the first asset tag, a second ranging signal that was transmitted from a device a known delay after the first ranging signal was received. The system further includes means for computing, at the first asset tag, a pseudo-range between the first asset tag and the device based on a time difference between sending the first ranging signal and receiving the second ranging signal.

A computer program product for position location in accordance with one or more aspects of the present disclosure includes a non-transitory computer-readable medium having non-transitory program code recorded thereon. The program code includes program code to send a first ranging signal from a first asset tag. The program code also includes program code to receive, at the first asset tag, a second ranging signal that was transmitted from a device a known delay after the first ranging signal was received. The program code further includes program code to compute, at the first asset tag, a pseudo-range between the first asset tag and the device based on a time difference between sending the first ranging signal and receiving the second ranging signal.

A method within a position location system in accordance with one or more aspects of the present disclosure includes receiving, at an asset tag, a first ranging signal from a first known location. Such a method further includes receiving, at the asset tag, a second ranging signal that was transmitted from a device having a second known location a known delay after the first ranging signal was received at the device. The method also includes computing, at the asset tag, a pseudo-range between the asset tag and the first known location and/or the second known location based on a time difference of arrival of the first ranging signal and the second ranging signal.

A position location apparatus in accordance with one or more aspects of the present disclosure includes a memory and at least one processor coupled to the memory. The processor(s) is configured to receive, at an asset tag, a first ranging signal from a first known location. The processor(s) is also configured to receive, at the asset tag, a second ranging signal that was transmitted from a device having a second known location a known delay after the first ranging signal was received at the device. The processor(s) is further configured to compute, at the asset tag, a pseudo-range between the asset tag and the first known location and/or the second known location based on a time difference of arrival of the first ranging signal and the second ranging signal

A position location apparatus in accordance with one or more aspects of the present disclosure includes means for receiving a first ranging signal from a first known location and for receiving a second ranging signal that was transmitted from a device having a second known location a known delay after the first ranging signal was received at the device. Such an apparatus further includes means for computing a pseudo-range between the receiving means and the first known location and/or the second known location based on a time difference of arrival of the first ranging signal and the second ranging signal.

A computer program product for position location in accordance with one or more aspects of the present disclosure includes a non-transitory computer-readable medium having non-transitory program code recorded thereon. The program code includes program code to receive, at an asset tag, a first ranging signal from a first known location. The program code also has program code to receive, at the asset tag, a second ranging signal that was transmitted from a device having a second known location a known delay after the first ranging signal was received at the device. The program code also includes program code to compute, at the asset tag, a pseudo-range between the asset tag and the first known location and/or the second known location based on a time difference of arrival of the first ranging signal and the second ranging signal.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a diagram of a communication system according to one aspect of the disclosure.

FIG. 2 is a block diagram illustrating an exemplary hardware configuration of wireless nodes used in the communication system, such as the position location system illustrated in FIG. 4.

FIG. 3 illustrates a diagram of a peer-to-peer network according to one aspect of the disclosure.

FIG. 4 is a diagram illustrating a position location system according to one aspect of the disclosure.

FIG. 5 is a flow chart illustrating a position location method implemented in the position location system illustrated in FIG. 4 according to one aspect of the disclosure.

FIG. 6 is a flow chart illustrating a position location method implemented in the communication system illustrated in FIG. 4 according to one aspect of the disclosure.

FIGS. 7-9 illustrate timing and transmission protocols to allow access points to compensate for time error caused by presence of different clocks at the access points and the asset tags, in accordance with aspects of the present disclosure.

FIG. 10 is a flow chart illustrating a method in accordance with various aspects of the present disclosure.

FIG. 11 is a flow chart illustrating a method in accordance with another aspect of the present disclosure.

FIG. 12 is a flow chart illustrating a method in accordance with another aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

In one aspect of the disclosure, a position location system tracks the location of assets (e.g., users) using a device that that may be worn by an asset, referred to as an “asset tag.” The asset tag may support wireless node functionality (e.g., a wireless station and/or a wireless node of a peer-to-peer network), or other like radio access technology. It should be recognized that asset tag operation to enable the position location system may be incorporated into a wireless handheld device of a user. The asset tags may also be incorporated in ad-hoc and/or peer-to-peer network implementations in which wireless peer nodes and/or wireless stations discover and communicate directly without access points. A wireless station can be a dedicated access point or a temporary access point (e.g., a soft access point) configured for access point functionality, for example, when operating according to a wireless local area network (WLAN) infrastructure mode. In a WLAN ad-hoc mode, or peer-to-peer network, the wireless stations/peer nodes discover and communicate directly without an access point, and the asset tags communicate with the wireless stations and/or peer nodes.

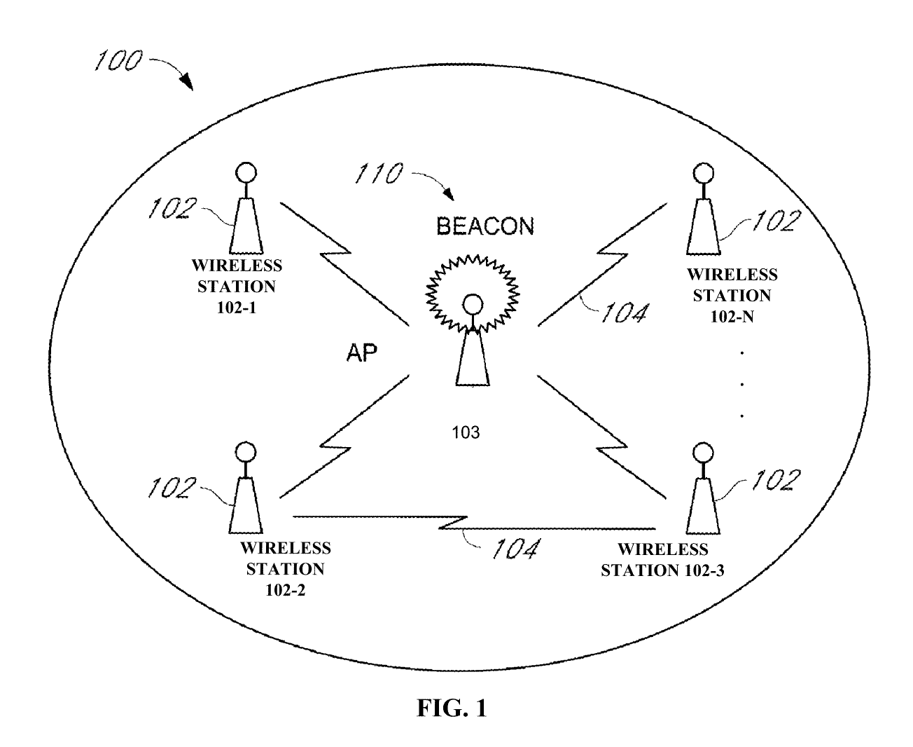

In one aspect of the disclosure, the asset tags transmit known preambles that are received by multiple access points (APs). The access points may estimate and send a time of arrival (TOA) of the preamble from a specific asset tag to a position location server. The position location server processes received TOAs from the multiple access points to estimate the position of the asset tags. In another configuration, the access points transmit a known beacon signal that is received by all asset tags in the respective coverage area of the access points. In this configuration, the asset tags make time difference of arrival (TDOA) measurements from the received beacon signals from different access points. The asset tags may compute their position based on the TDOA measurements or send the TDOA measurements to a position location server (PLS) for position location computation. The position location system may be implemented in various wireless networks, such as the WLAN configuration shown in FIG. 1.

One example of a wireless communication system 100 is illustrated in FIG. 1. The wireless communication system 100 may include a number of wireless stations 102 (102-1 . . . 102-N) and access points 103 that can communicate with one another over wireless links 104. Although the wireless communication system 100 is illustrated with five wireless stations/access points 102/103, it should be appreciated that any number of stations and access points (wired or wireless) may form the wireless communication system 100. In the illustration, the access points 103 are dedicated access points. Alternatively, the access points 103 may be configured for access point functionality (e.g., as a soft access point).

The wireless stations/access points 102/103 may be any device configured to send and receive wireless communications, such as a laptop computer, smartphone, a printer, a personal digital assistant, a camera, a cordless telephone, a session initiation protocol phone, a handheld device having wireless connection capability, a user equipment, an access terminal, or any other suitable device. In one aspect of the disclosure, the wireless stations/access points 102/103 are incorporated into a tag that is placed on an asset (e.g., a user). In the wireless communication system 100, the wireless stations/access points 102/103 may be distributed throughout a geographic region. Further, each wireless station/access point 102/103 may have a different coverage region over which it may communicate. The access points 103 may include or be implemented as a base station, a base transceiver station, a terminal, a wireless node operating as an access point, or the like. The wireless stations/access points 102/103 in the wireless communication system 100 may communicate wirelessly using any suitable wireless network standard.

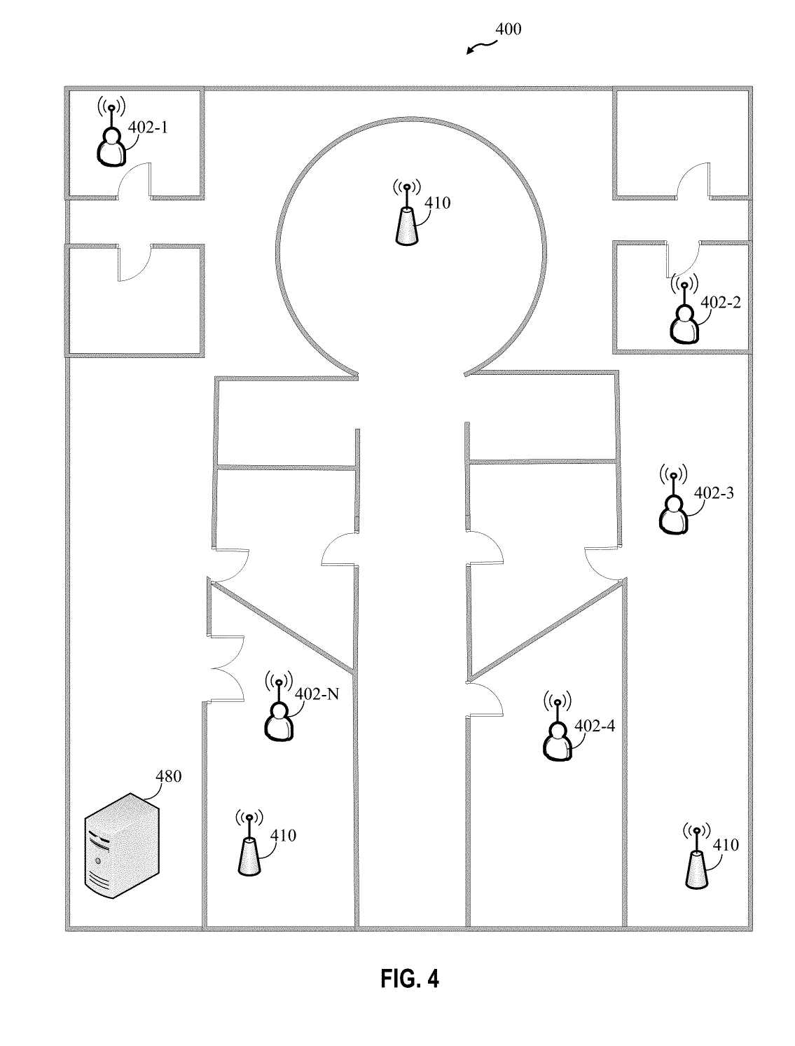

In one configuration, an asset tag may be configured as one of the wireless stations 102 that associates with one of the access points 103 to send and/or receive position information from one of the access points 103 according to an initial wireless access message 110 (e.g., beacon) broadcast by one of the access points 103. In one aspect of the disclosure, the asset tags measure beacon signals from access points 103 and compute an asset tag position. Alternatively, the asset tags transmit the beacon measurements to a position location server. In another configuration, the asset tags transmit known preambles that are received by the access points 103. The access points 103 may estimate and send the time of arrival (TOA) of the preamble from a specific tag to the position location server that estimates the position of the asset tags. Position location computations may be carried out at the position location server using the TOAs and/or TDOAs received from the different access points 103, for example, as shown in FIG. 4.

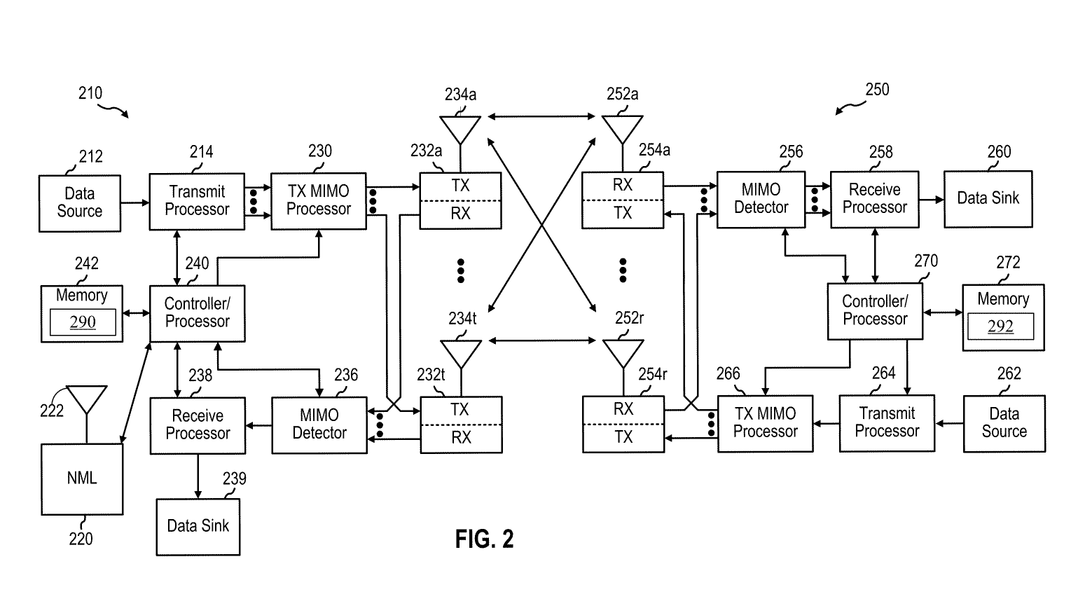

FIG. 2 shows a block diagram of a design of an access point 210 and a wireless station 250, each of which may be one of the wireless nodes in FIGS. 1, 3, and 4. Each of the wireless nodes in the wireless communication system 100 may include a wireless transceiver to support wireless communication and controller functionality to manage communication over the network. The controller functionality may be implemented within one or more digital processing devices. The wireless transceiver may be coupled to one or more antennas to facilitate the transmission and reception of signals over a wireless channel.

In one configuration, the access point 210 may be equipped with antennas 234 (234a, . . . , 234t), and the wireless station 250 may be equipped with antennas 252 (252a, . . . , 252r).

At the access point 210, a transmit processor 214 may receive data from a data source 212 and control information from a controller/processor 240. The transmit processor 214 may process (e.g., encode and symbol map) the data and control information to obtain data symbols and control symbols, respectively. The transmit processor 214 may also generate reference symbols, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the transceivers 232 (232a, . . . , 232t). Each of the transceivers 232 may process a respective output symbol stream to obtain an output sample stream. Each of the transceivers 232 may further process (e.g., convert to analog, amplify, filter, and upconvert) the output sample stream to obtain a transmission signal. Signals from transceivers 232 may be transmitted via the antennas 234 (234a, . . . , 234t), respectively.

At the wireless station 250, the antennas 252 (252a, . . . , 252r) may receive the signals from the access point 210 and may provide received signals to the transceivers 254 (254a, . . . , 254r), respectively. Each of the transceivers 254 may condition (e.g., filter, amplify, downconvert, and digitize) a respective received signal to obtain input samples. Each of the transceivers 254 may further process the input samples to obtain received symbols. A MIMO detector 256 may obtain received symbols from all of the transceivers 254, perform MIMO detection on the received symbols if applicable, and provide detected symbols. A receive processor 258 may process (e.g., demodulate, deinterleave, and decode) the detected symbols, provide decoded data for the wireless station 250 to a data sink 260, and provide decoded control information to a controller/processor 270.

When transmitting from the wireless station 250, a transmit processor 264 may receive and process data from a data source 262 and control information from the controller/processor 270. The transmit processor 264 may also generate reference symbols for a reference signal. The symbols from the transmit processor 264 may be precoded by a TX MIMO processor 266 if applicable, further processed by the transceivers 254, and transmitted to the access point 210. At the access point 210, the signals received from the wireless station 250 may be received by the antennas 234, processed by the transceivers 232, detected by a MIMO detector 236 if applicable, and further processed by a receive processor 238 to obtain decoded data and control information sent by the wireless station 250. The receive processor 238 may provide the decoded data to a data sink 239 and the decoded control information to the controller/processor 240. The access point 210 can send messages to other base stations, for example, over a backhaul link. In one configuration, the access point includes a narrowband messaging link (NML) 220 having an antenna 222 for enabling synchronization and ranging initialization between asset tags and access points of an in-door position location system, for example, as shown in FIG. 4. It should be recognized that the wireless station 250 may also be configured to include a narrowband message link, such as the narrowband messaging link 220 of the access point 210, although it is not shown.

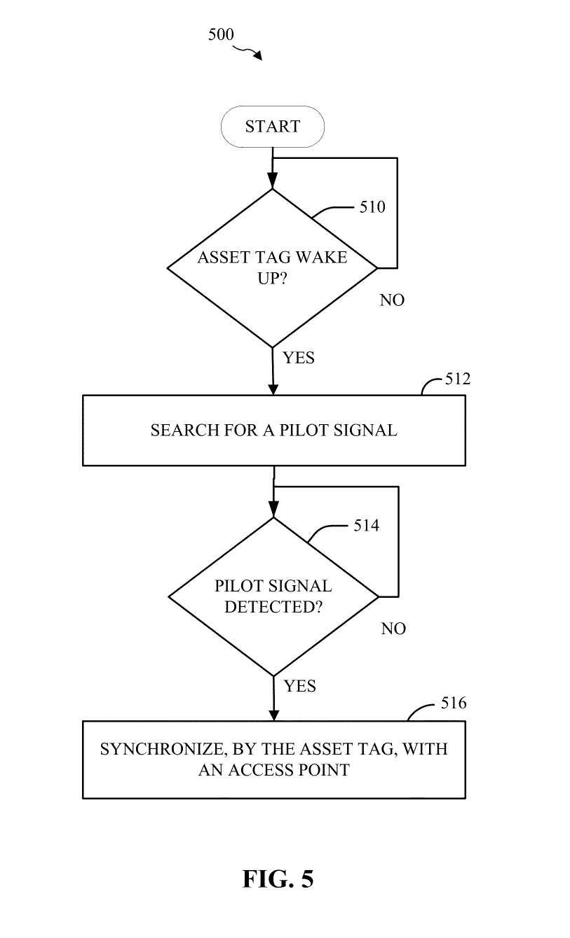

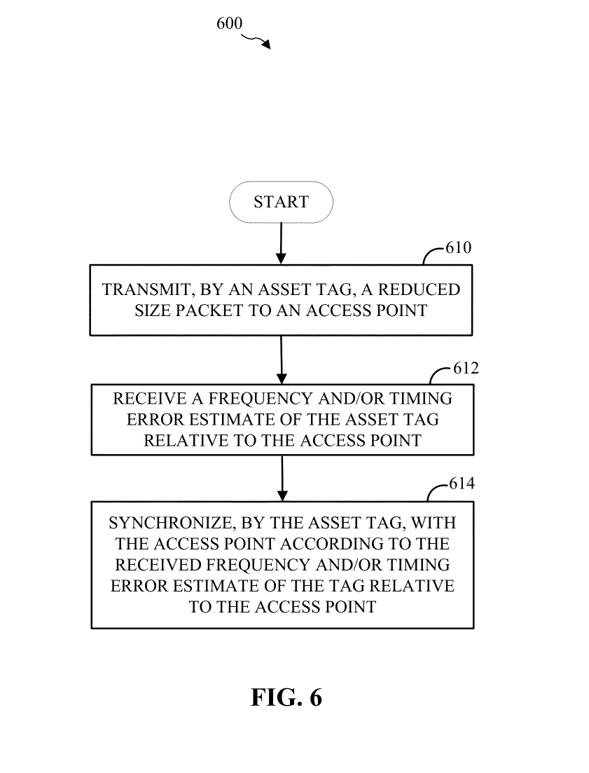

The controller/processor 240 may direct the operation at the access point 210 and the controller/processor 270 may direct the operation at wireless station 250, respectively. The controller/processor 270 and/or other processors and modules at the wireless station 250 may perform or direct the execution of the functional blocks illustrated in method flow charts of FIGS. 5 and 6 and/or other processes for the techniques described herein. The memory 242 may store data and program codes for the access point 210 and the memory 272 may store data and program codes for the wireless station 250. For example, the memory 272 of the wireless station 250 may store a position location module 292 which, when executed by the controller/processor 270, configures the wireless station 250 for operation within a position location system, for example, as shown in FIG. 4. Similarly, the memory 242 of the access point 210 may store a position location module 290 which, when executed by the controller/processor 240, configures the access point 210 for operation within the position location system shown in FIG. 4.

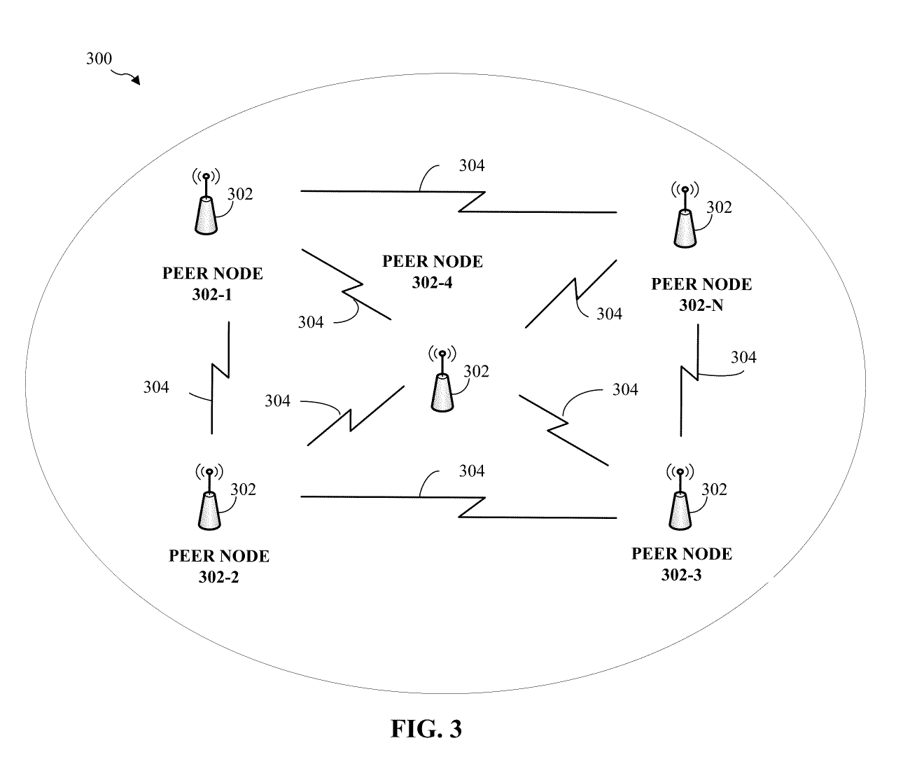

FIG. 3 illustrates a diagram of a peer-to-peer network 300 according to one aspect of the disclosure. In some aspects, a peer-to-peer network 300 may be established between two or more peer nodes 302 (302-1, 302-2, 302-3, 302-4, . . . 302-N). The peer nodes 302 in the peer-to-peer network 300 may communicate wirelessly using any suitable wireless network standard. The peer-to-peer network 300 may include a number of peer nodes 302 that can communicate with one another over wireless links 304. An asset tag may be configured according to the wireless station 250 of FIG. 2, and operate as one of the peer nodes 302 of the peer-to-peer network 300.

An asset tag may be any device configured to send and receive wireless communications, such as a laptop computer, a smartphone, a printer, a personal digital assistant, a camera, a cordless telephone, a session initiation protocol phone, a handheld device having wireless connection capability, a user equipment, an access terminal, or any other suitable device that may be worn as an asset tag.

For example, an asset tag that operates as one of the peer nodes 302-1 may associate with another of the peer nodes 302-4 to transmit known preambles that are received by the peer nodes 302. One of the peer nodes 302-1 may estimate and send the time of arrival (TOA) of the preamble from a specific asset tag to a position location server (not shown) that estimates the position of the asset tags. Position location computations may be carried out at the position location server using the TOAs received from the different peer nodes 302. In another configuration, the peer nodes 302 transmit a known beacon signal, which is typically a wide bandwidth beacon signal which is received by all asset tags in the respective coverage area of the peer nodes. In this configuration, the asset tags make TOA and/or TDOA measurements on the received beacon signals from different peer nodes 302 and either compute the position at the asset tag or send the measurements to the position location server for position location computation.

FIG. 4 is a diagram illustrating a position location system 400 according to one aspect of the disclosure. The position location system 400 may track assets (e.g., people) using asset tags 402 (402-1, . . . , 402-N) that assets wear. The asset tags 402 may be configured according to the wireless station 250 of FIG. 2 to support wireless node functionality (e.g., wireless stations and/or a wireless nodes of a peer-to-peer network), or other like radio access technology.

As shown in FIG. 4, the position location system 400 includes the asset tags 402, access points (APs) 410 installed on the premises, and a position location server 480 that estimates the position of the asset tags 402. In one configuration, the asset tags 402 transmit known preambles that are received by the access points 410. The access points 410 may estimate and send the time of arrival (TOA) of the preamble from a specific asset tag to the position location server 480. Position location computations may be carried out at the position location server 480 using the TOAs received from the different access points 410. This approach may help reduce the power consumption at the asset tags 402.

In another configuration, the access points 410 transmit a known beacon signal, which is received by all asset tags 402 in the respective coverage area of the access points 410. In this configuration, the asset tags 402 make TDOA measurements based on the received beacon signals (also referred to as “pilots”) from different access points 410. The asset tags 402 may either compute the position at one of the asset tags 402 or send the measurements to the position location server 480 for position location computation. In the configuration where the asset tags 402 measure the beacon signals from access points 410 and compute their respective position without the position location server 480, higher power consumption at the asset tags 402 may lower battery life.

The position location system 400 recognizes that the two basic functions of a tracking system, messaging and positioning, have different specifications. For messaging, one of the asset tags 402-1 communicates with one of the access points 410 (e.g., closest to the asset tag), in which a small amount of data is exchanged. As a result, bandwidth is not a primary concern in the messaging portion of the position location system 400. For positioning, ranging measurements may be made between asset tags 402 and multiple ones of the access points 410. As a result, the ranging operation may involve a longer access distance. Moreover, a wide bandwidth for a ranging signal is desired to achieve accurate range measurements. In one configuration, the position location system 400 provides the messaging and coarse synchronization portion of the air interface of the system architecture on a first air interface (messaging link) and the ranging portion of the system architecture on a second air interface (ranging link). For example, the position location server 480 may be configured as shown in FIG. 2, in which one of the antennas 234 provides a ranging link and a narrowband messaging link 220 provides a messaging link.

In one configuration, a narrowband messaging link (e.g., narrowband messaging link 220 of FIG. 2) is used for a messaging and coarse synchronization to enable a subsequent ranging measurement. The narrowband messaging link 220 may be used by the asset tags 402 to communicate with access points 410 installed on the premises, as well as to provide coarse synchronization between the access points 410 and also between the access points 410 and the asset tags 402. In one configuration, the asset tags 402 wake up periodically and search for beacon signals transmitted by access points 410 on a relatively narrowband signal, such as one MHz of bandwidth using, for example the narrowband messaging link 220, versus many tens or hundreds of MHz of bandwidth for a ranging link. The asset tags 402 detect the beacon signal and synchronize with one of the access points 410 within the coarse time of the narrowband signal. In another configuration, the asset tags 402, after waking up from sleep mode, send a small size packet to the access points 410 that the access points 410 use to measure a time and frequency error of the asset tags 402 with respect to the access points 410.

In this configuration, the access points 410 send the measurement results and other ranging related scheduling information back to the asset tags 402 after a predetermined delay. The asset tags 402 use the frequency and timing errors reported by the access points 410 to pre-correct their frequency and timing offset prior to sending a preamble to the access points 410. Pre-correcting at the asset tags 402 reduces an amount of time for performing a frequency and timing search at the access points 410. Once the coarse time synchronization is achieved, a ranging operation begins by exchanging preambles between the asset tags 402 and the access points 410. The coarse time synchronization allows a reduced search window in the ranging link. The asset tags 402 may also communicate with other asset tags in a peer-to-peer mode and measure a range between themselves on the ranging link (e.g., one the antennas 252 of FIG. 2). The coarse synchronization between the asset tags 402 obtained from the narrowband messaging link (e.g., the narrowband messaging link 220 of FIG. 2) helps the asset tags 402 reduce their search window when estimating a range in the peer-to-peer mode on a wideband ranging link (e.g., one of the antennas 252).

Ranging methods are generally divided into two categories: (1) received signal strength indicator (RSSI) based ranging; and (2) propagation delay based ranging. One drawback of RSSI based ranging methods is the difficulty in achieving robust and accurate mapping from RSSI to range, because RSSI based ranging is also dependent on environmental factors like blockage and fading. Moreover, path loss is an exponential function of distance. As a result, the sensitivity of RSSI based methods to the distance change decreases as the separation distance grows, which reduces accuracy in RSSI based ranging systems. Therefore, RSSI based methods generally have limited ranging accuracy and involve a higher density of access points.

Propagation delay based methods may measure the time-of-flight (TOF), the round-trip delay time (RTT), or the time-difference-of-arrival (TDOA) directly between the access point 410 and asset tags 402, and/or between asset tags 402 individually. The positioning accuracy of these methods are more dependent on the signal bandwidth and the detection signal to interference plus noise ratio (SINR). The wider the bandwidth of the ranging signal, the better the accuracy of the ranging. As such, for ranging operations, a wide bandwidth is beneficial for accurate measurement of propagation delay between asset tags 402 and between asset tags 402 and access point 410.

In the configuration of FIG. 4, the wideband ranging link enables a ranging operation between the asset tags 402, the access points 410, and the position location server 480 of the position location system 400. In this configuration, the position location server 480 determines a location of at least one of the asset tags 402 according to the ranging operation.

The wideband ranging link may be scheduled through the narrowband messaging link. In one configuration, the asset tags 402 specified for a ranging operation are known when the wideband ranging preamble is transmitted and what preamble, e.g., pseudo noise (PN), sequence is used based on scheduling information received through the narrowband messaging link. In this configuration, the amount of time in which the asset tags 402 are active may be reduced by using the scheduling information received through the narrowband messaging link.

In one configuration, a duration of the preamble that the asset tags 402 transmit is limited to reduce power consumption at the asset tags 402.

One preamble design used in existing systems, such as the CDMA2000 family of protocols, includes a known preamble that is used on a given access channel between the asset tags 402 and the access points 410. There are multiple access channels, and different asset tags 402 may be assigned to different access channels. Devices that simultaneously transmit a preamble may be assigned a different pseudo-random sequence or the same pseudo-random sequence with a different offset. The preamble signal may comprise this known sequence to provide an asset tag identification (ID). To avoid different asset tags 402 from sending their preambles at the same time, the preamble transmission times of different asset tags 402 may be separated in time based on IDs of the asset tags 402 and/or hashing algorithms known to the asset tags 402 and to the access points 410.

The preamble may be associated with a signal sent by the asset tag 402 for ranging on a wideband message link, which transmission time may be scheduled by the narrowband messaging link 220. Through narrowband messaging link scheduling, different asset tags 402 can be scheduled to send their preamble at different times or simultaneously. When the asset tags 402 are scheduled to send their preambles simultaneously, different pseudo-random sequences or the same pseudo random sequence with a different offset can be used to differentiate the different asset tags 402.

FIG. 5 is a flow chart illustrating a position location initialization method 500 implemented in the position location system of FIG. 4. At block 510, the method begins by determining whether an asset tag is awake by detecting an asset tag wakeup. For example, as shown in FIG. 4, the asset tags 402 periodically wake up as part of a synchronization process. At block 512, the asset tag searches for a beacon signal. For example, the access points 410 periodically transmit a beacon signal for detection by the asset tags 402. At block 514, it is determined whether the asset tag detects the beacon signal. Once detected, the asset tag synchronizes with the access point that transmitted the beacon signal at block 516. In one configuration, the beacon signal includes a known preamble or a pseudo noise (PN) code as an access point identification field. In this configuration, the access points 410 send out the beacon signals to identify themselves. The access points 410 may not know which asset tag 402 is listening. Because there may be multiple asset tags 402, an asset tag identification field (ID) may be included in the beacon signal. FIGS. 5 and 6 describe two different ways to achieve coarse synchronization and scheduling information. FIG. 5 describes achieving coarse synchronization and/or scheduling information through a downlink beacon or pilot from the access points 410. FIG. 6 describes achieving coarse synchronization and/or scheduling information through a beaconless mode initiated by the station, e.g., the access point 410 or the position location server 480.

FIG. 6 is a flow chart illustrating a position location synchronization method 600 implemented in the position location system 400 of FIG. 4. At block 610, an asset tag transmits a short packet to an access point. For example, as shown in FIG. 4, the asset tags 402 transmit a short packet to the access points 410 using a narrowband message link (e.g., the narrowband messaging link 220). At block 612, the asset tag receives a frequency and/or timing error estimate of the asset tag relative to the access point. At block 614, the asset tag synchronizes with the access point according to the received frequency and/or timing error estimate of the asset tag relative to the access point 410. Once synchronized, a ranging operation with the access point may be initiated. For example, as shown in FIG. 4, the ranging operation may be performed by the access points 410 and/or the position location server 480 to determine a location of one of the asset tags 402-1.

Ranging Measurement Mechanism

In a propagation delay based ranging system, one commonly used positioning computation method is trilateration, which involves measuring pseudo-range time-of-flight (TOF) or equivalently, Round-Trip-Time ((RTT, also called Round-Trip Delay), and/or measuring the difference of pseudo range time-difference-of-arrival (TDOA). Traditionally TOF/RTT or TDOA measurements are performed individually for each asset tag 402. In a position location system 400, or in other systems or networks that track the asset tags 402, especially where a large number of asset tags 402 are being tracked and their positions and ranges are being determined, it is desirable to efficiently perform TOF/RTT or TDOA measurements for multiple devices simultaneously. Efficient measuring reduces the total air time used to transmit positioning measurements and extends the battery life of asset tags 402.

Using information from the asset tags 402 and the access points 410, a scheduler, which may be at the position location server 480 can determine a ranging schedule for any one or more of the asset tags 402 using CDMA (code division multiple access) and/or TDMA (time division multiple access) multiple access protocols. Thus, ranging of multiple asset tags 402 can be performed simultaneously or at least substantially simultaneously. The ranging schedule can be communicated to the access point 410 and/or the asset tags 402 using a messaging link, such as the narrowband messaging link 220. The information from the asset tags 402 and access points 410 may be the received signal strength indicator (RSSI) obtained through the narrowband messaging link 220.

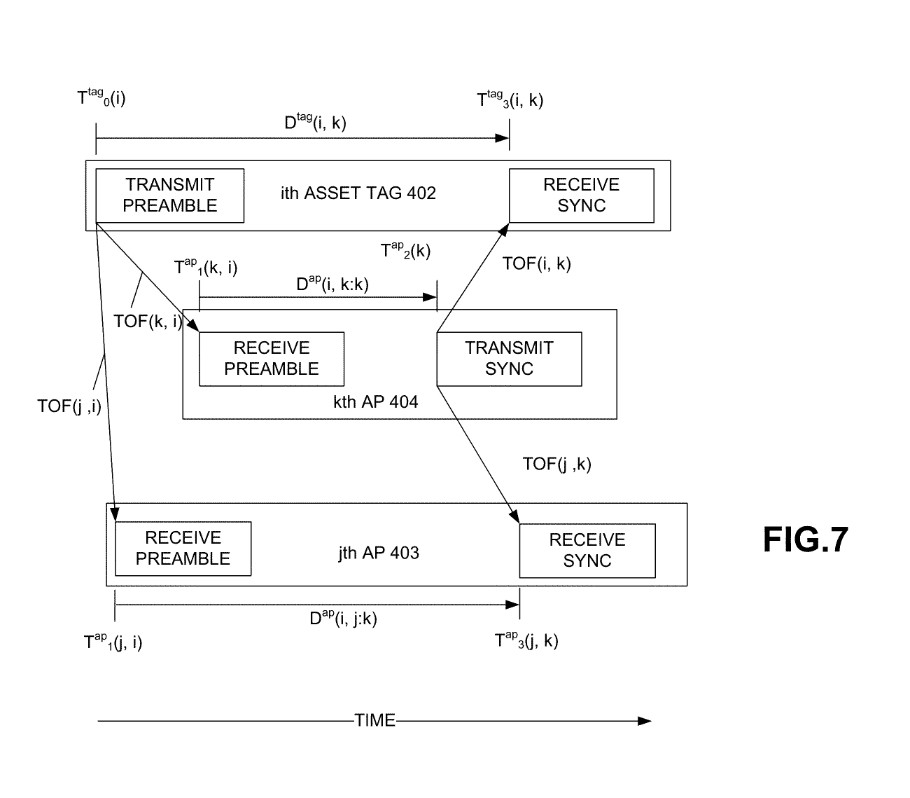

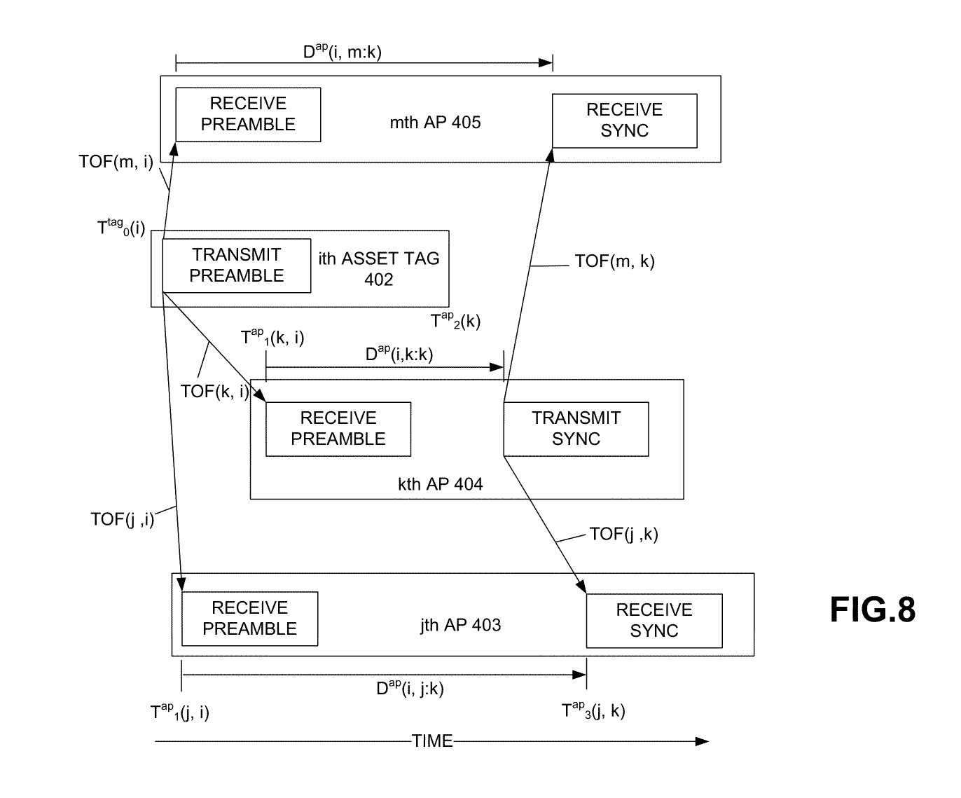

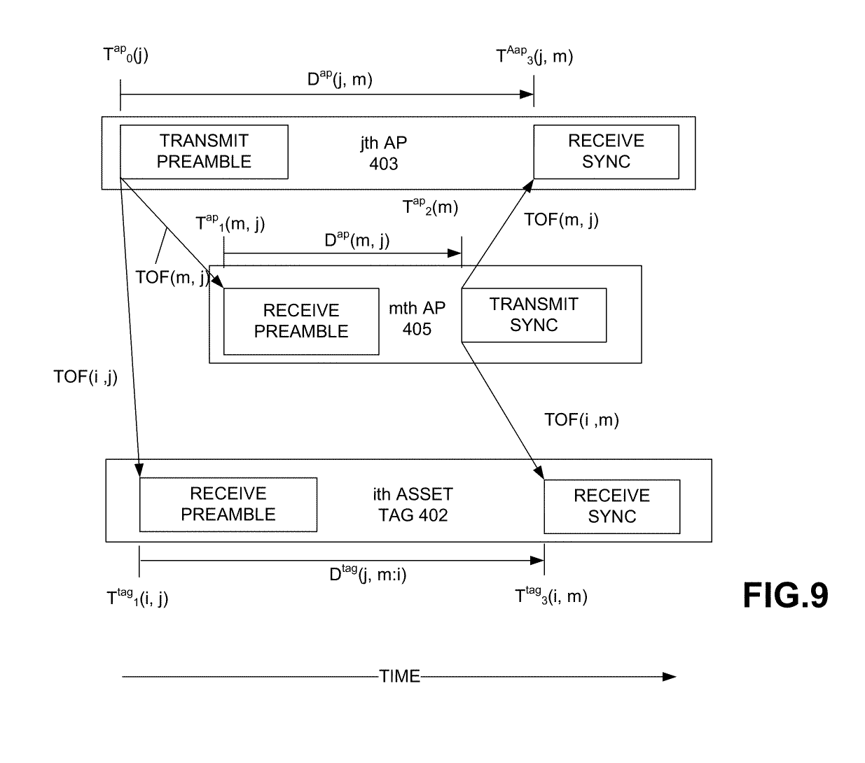

Three different TOF/TDOA measurement schemes in accordance with an aspect of the present disclosure are described with respect to FIGS. 7-9. FIGS. 7 and 8 describe the uplink TOF and TDOA measurement schemes, respectively. FIG. 9 describes the downlink TDOA measurement scheme. In the following description, the uplink direction is from the asset tags 402 to the access points 410.

As shown in FIG. 7, at a scheduled time in accordance with the ranging schedule, an asset tag 402 transmits its own individual preamble. The preamble may optionally include the local time when the preamble was sent. Although not shown in FIG. 7, other asset tags also transmit their own preamble at the scheduled time. The local scheduled time for each asset tag will be denoted as T₀^{tag}(i) where i is the index of the asset tag 402.

Each access point detects the earliest arrival of the preamble from each access tag. As seen in FIG. 7, the jth access point 403 detects the preamble from the ith asset tag 402 at the access point local time, T₁^{ap}(j, i). The time of flight (TOF) from the ith asset tag 402 is denoted as TOF (j, i). Similarly, the kth access point 404 detects the earliest arrival signal from the ith asset tag 402 at the access point local time T₁^{ap}(k, i). The time of flight (TOF) from the ith asset tag 402 is TOF (k, i).

After the asset tags finish transmission of the preambles, a designated one of the access points, the kth access point 404 in this example, transmits a group SYNC preamble at its local time T₂^{ap}(k). The SYNC preamble is sent after a delay D^{ap}(i, k; k). The other access points and asset tags detect the earliest arrival of the group SYNC preamble signal. For example, the ith asset tag 402 detects earliest arrival of the SYNC preamble signal at a local time T₃^{tag}(i, k) and the jth access point detects earliest arrive at a local time T₃^{ap}(j, k).

In one aspect of the present disclosure, the following equations may be used to compute the time of flight (TOF) between the asset tags 402 and the access points 403, 404.

The ith asset tag 402 reports the time difference D^{tag}(i;k)=T₃^{tag}(i,k)−T₀^{tag}(i) to the position location server 480. The kth access point 404 reports the delay D^{ap}(i,k;k)=(T₂^{ap}(k) −T₁^{ap}(k,i). The jth access point 403 reports the delay D^{ap}(i,j;k)=(T₃^{ap}(j, k)−T₁^{ap}(j,i)).

The time-of-flight (TOF) between the kth access point 404 and ith asset tag 402 is denoted as TOF (k,i) and can be calculated, for example, as (D^{tag}(i;k)−D^{ap}(i,k;k))/2. The TOF between the jth access point 403 and ith asset tag 402 is denoted as TOF (j,i) and can be calculated, for example, as TOF(k,i)+D^{ap}(i,k;k)−D^{ap}(i,j;k)+d(j,k)/c, where d(j,k) is the known distance between the jth and the kth access points 403, 404 and c is the signal speed.

To improve the measurement accuracy, the process may be repeated multiple times. Each time a different access point may send the group SYNC preamble.

FIG. 8 illustrates an exemplary uplink time difference of arrival (TDOA) measurement process. The TDOA can be measured using a similar process as that of the TOF measurements shown in FIG. 7, except that the asset tags 402 do not receive or report any time measurements. In this process, an additional access point, denoted the mth access point 405 is used.

There is a time of flight measurement TOF (m, i) associated with the TOF between the ith asset tag 402 and the mth access point 405. The TDOA between the transmission time of the ith asset tag preamble and arrival of the ith asset tag preamble at the jth access point 403 and mth access point 405 is denoted as TDOA(j,m;i) and can be calculated, for example, as D^{ap}(i,m;k)−D^{ap}(i,j;k)+(d(j,k)−d(m,k))/c. The time of flight measurements, TOF (m, k) and TOF (j, k), may assist in determining other measurements described with respect to FIG. 7.

FIG. 9 illustrates an exemplary downlink TDOA measurement process. In the downlink TDOA measurements, the ith asset tag 402 does not transmit a ranging signal (i.e., preamble). The ith asset tag 402, instead, receives a ranging signal from multiple access points (jth access point 403 shown in FIG. 9) and the group SYNC signal from one of the access points (mth access point 405 in FIG. 9). Using the above terminology, the TDOA between the jth and mth access points 403, 405 and the ith of asset tag 402 is denoted by TDOA(j,m;i) and can be calculated, for example, as (D^{ap}(j;m)+D^{ap}(m;j))/2−D^{tag}(j,m;i).

In one configuration, a position location apparatus includes means for receiving a first ranging signal from an asset tag. The apparatus also has means for receiving, from another device, a second ranging signal that was transmitted a known delay after the first ranging signal. In one aspect of the disclosure, the receiving means may be the access point 410 or other means configured to perform the functions recited by the receiving means. In this configuration, the position location apparatus also includes means for computing a pseudo-range. In one aspect of the disclosure, the computing means may be the controller/processor 240 or other means configured to perform the functions recited by the computing means. In another aspect, the aforementioned means may be any module or any apparatus configured to perform the functions recited by the aforementioned means.

In another configuration, a position location apparatus includes means for sending a first ranging signal from a first asset tag. In one aspect of the disclosure, the sending means may be the asset tag 402 or other means configured to perform the functions recited by the sending means. In this configuration, the position location apparatus also includes means for receiving, at the first asset tag, a second ranging signal. In one aspect of the disclosure, the receiving means may be the asset tag 402 or other means configured to perform the functions recited by the receiving means. In this configuration, the position location apparatus also includes means for computing, at the first asset tag, a pseudo-range. In one aspect of the disclosure, the computing means may be the controller/processor 240 or other means configured to perform the functions recited by the computing means. In another aspect, the aforementioned means may be any module or any apparatus configured to perform the functions recited by the aforementioned means.

In another configuration, a position location apparatus includes means for receiving a first ranging signal from a first known location and for receiving a second ranging signal that was transmitted from a device having a second known location a known delay after the first ranging signal was received at the device. In one aspect of the disclosure, the receiving means may be the asset tag 402 or other means configured to perform the functions recited by the receiving means. In this configuration, the position location apparatus also includes means for computing a pseudo-range. In one aspect of the disclosure, the computing means may be the controller/processor 240 or other means configured to perform the functions recited by the computing means. In another aspect, the aforementioned means may be any module or any apparatus configured to perform the functions recited by the aforementioned means.

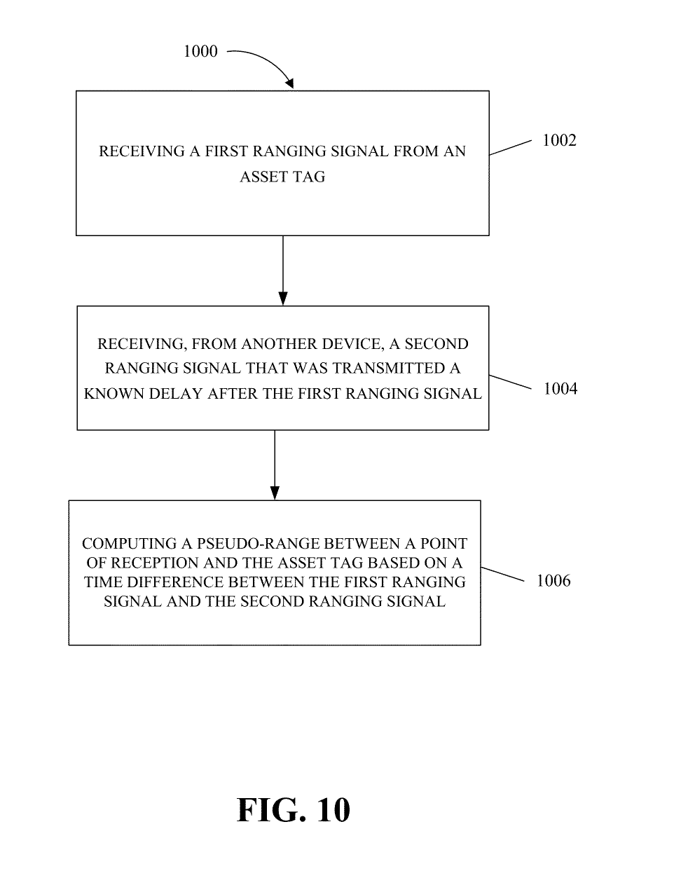

FIG. 10 is a flow chart illustrating a method 1000 in accordance with an aspect of the present disclosure. At block 1002, a first ranging signal is received from an asset tag. At block 1004, a second ranging signal is received from another device. The second ranging signal was transmitted a known delay after the first ranging signal. At block 1006 a pseudo-range is computed between a point of reception and the asset tag based on a time difference between the first ranging signal and the second ranging signal.

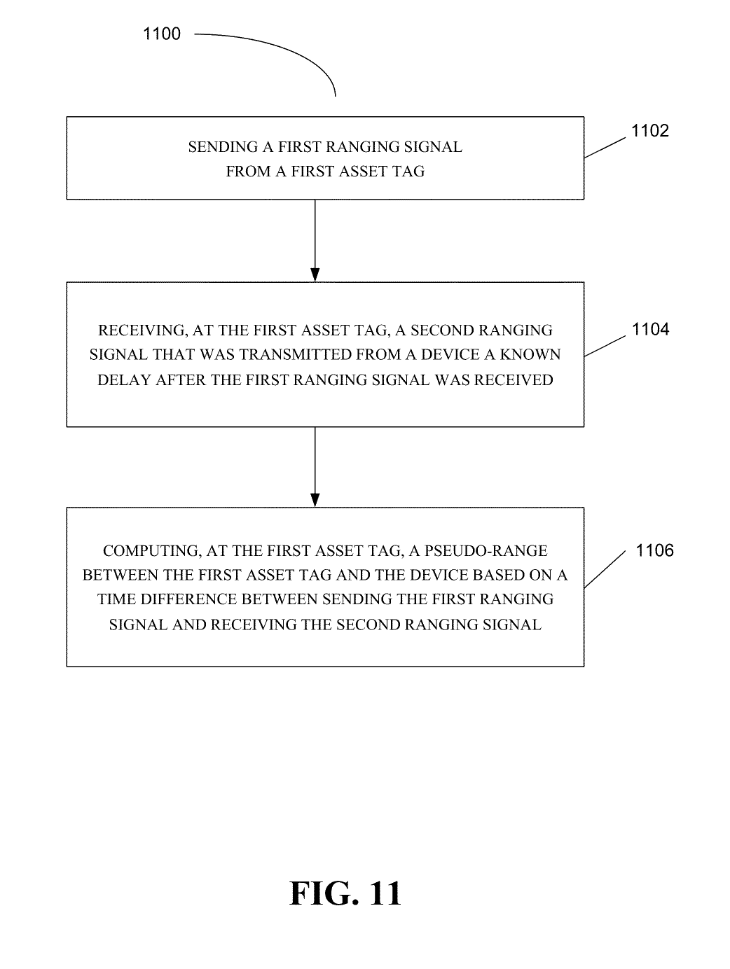

FIG. 11 is a flow chart illustrating a method 1100 in accordance with another aspect of the present disclosure.

Block 1102 illustrates sending a first ranging signal from a first asset tag.

Block 1104 illustrates receiving, at the first asset tag, a second ranging signal that was transmitted from a device a known delay after the first ranging signal was received.

Block 1106 illustrates computing, at the first asset tag, a pseudo-range between the first asset tag and the device based on a time difference between sending the first ranging signal and receiving the second ranging signal.

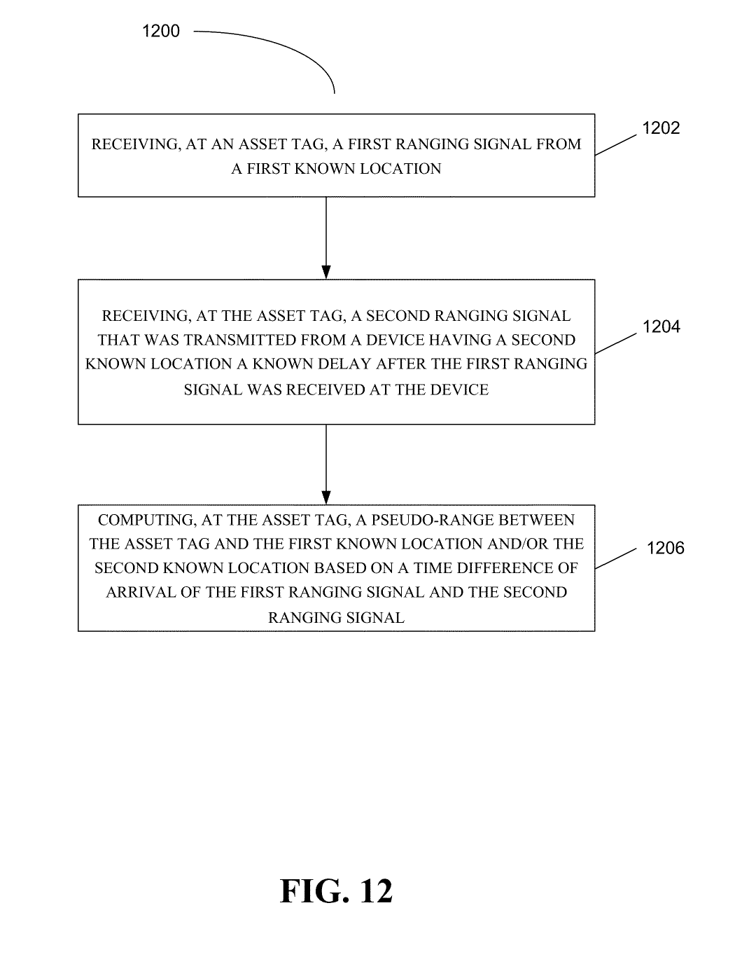

FIG. 12 is a flow chart illustrating a method 1200 in accordance with another aspect of the present disclosure.

Block 1202 illustrates receiving, at an asset tag, a first ranging signal from a first known location.

Block 1204 illustrates receiving, at the asset tag, a second ranging signal that was transmitted from a device having a second known location a known delay after the first ranging signal was received at the device.

Block 1206 illustrates computing, at the asset tag, a pseudo-range between the asset tag and the first known location and/or the second known location based on a time difference of arrival of the first ranging signal and the second ranging signal.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method within a position location system, comprising:
receiving a first ranging signal from an asset tag;
receiving, from another device, a second ranging signal that was transmitted a known delay after the first ranging signal; and
computing a pseudo-range between a point of reception and the asset tag based at least in part on a time difference between the first ranging signal and the second ranging signal.

2. The method of claim 1, further comprising compensating for a relative delay based at least in part on reported delays occurring in the position location system.

3. The method of claim 1, in which the first ranging signal was sent according to a schedule.

4. The method of claim 3, further comprising using code division multiple access (CDMA) techniques and/or time division multiple access (TDMA) techniques to enable substantially simultaneous ranging of a plurality of asset tags.

5. A position location apparatus, comprising:
a memory; and
at least one processor coupled to the memory and configured:
to receive a first ranging signal from an asset tag;
to receive, from another device, a second ranging signal that was transmitted a known delay after the first ranging signal; and
to compute a pseudo-range between a point of reception and the asset tag based at least in part on a time difference between the first ranging signal and the second ranging signal.

6. A position location apparatus, comprising:
means for receiving a first ranging signal from an asset tag;
means for receiving a second ranging signal, from another device, that was transmitted a known delay after the first ranging signal; and
means for computing a pseudo-range between a point of reception and the asset tag based at least in part on a time difference between the first ranging signal and the second ranging signal.

7. A computer program product for position location, comprising:
a non-transitory computer-readable medium having non-transitory program code recorded thereon, the program code comprising:
program code to receive a first ranging signal from an asset tag;
program code to receive, from another device, a second ranging signal that was transmitted a known delay after the first ranging signal; and
program code to compute a pseudo-range between a point of reception and the asset tag based at least in part on a time difference between the first ranging signal and the second ranging signal.

8. A method within a position location system, comprising:
sending a first ranging signal from a first asset tag;
receiving, at the first asset tag, a second ranging signal that was transmitted from a device a known delay after the first ranging signal was received; and
computing, at the first asset tag, a pseudo-range between the first asset tag and the device based at least in part on a time difference between sending the first ranging signal and receiving the second ranging signal.

9. The method of claim 8, further comprising compensating for a relative delay based at least in part on reported delays occurring in the position location system.

10. The method of claim 8, in which the first ranging signal is sent according to a schedule.

11. The method of claim 10, further comprising using code division multiple access (CDMA) techniques and/or time division multiple access (TDMA) techniques to enable substantially simultaneous ranging of a plurality of asset tags.

12. A position location apparatus, comprising:
a memory; and
at least one processor coupled to the memory and configured:
to send a first ranging signal from a first asset tag;
to receive, at the first asset tag, a second ranging signal that was transmitted from a device a known delay after the first ranging signal was received; and
to compute, at the first asset tag, a pseudo-range between the first asset tag and the device based at least in part on a time difference between sending the first ranging signal and receiving the second ranging signal.

13. A position location apparatus, comprising:
means for sending a first ranging signal from a first asset tag;
means for receiving, at the first asset tag, a second ranging signal that was transmitted from a device a known delay after the first ranging signal was received; and
means for computing, at the first asset tag, a pseudo-range between the first asset tag and the device based at least in part on a time difference between sending the first ranging signal and receiving the second ranging signal.

14. A computer program product for position location, comprising:
a non-transitory computer-readable medium having non-transitory program code recorded thereon, the program code comprising:
program code to send a first ranging signal from a first asset tag;
program code to receive, at the first asset tag, a second ranging signal that was transmitted from a device a known delay after the first ranging signal was received; and
program code to compute, at the first asset tag, a pseudo-range between the first asset tag and the device based at least in part on a time difference between sending the first ranging signal and receiving the second ranging signal.

15. A method within a position location system, comprising:
receiving, at an asset tag, a first ranging signal from a first known location;
receiving, at the asset tag, a second ranging signal that was transmitted from a device having a second known location a known delay after the first ranging signal was received at the device; and
computing, at the asset tag, a pseudo-range between the asset tag and at least one of the first known location and the second known location based at least in part on a time difference of arrival of the first ranging signal and the second ranging signal.

16. The method of claim 15, further comprising compensating for a relative delay based at least in part on reported delays occurring in the position location system.

17. The method of claim 16, in which the first ranging signal is sent according to a schedule.

18. The method of claim 17, further comprising using code division multiple access (CDMA) techniques and/or time division multiple access (TDMA) techniques to enable substantially simultaneous ranging of a plurality of asset tags.

19. A position location apparatus, comprising:
a memory; and
at least one processor coupled to the memory and configured:
to receive, at an asset tag, a first ranging signal from a first known location;
to receive, at the asset tag, a second ranging signal that was transmitted from a device having a second known location a known delay after the first ranging signal was received at the device; and
to compute, at the asset tag, a pseudo-range between the asset tag and at least one of the first known location and the second known location based at least in part on a time difference of arrival of the first ranging signal and the second ranging signal.

20. A position location apparatus, comprising:
means for receiving a first ranging signal from a first known location and for receiving a second ranging signal that was transmitted from a device having a second known location a known delay after the first ranging signal was received at the device; and
means for computing a pseudo-range between the receiving means and at least one of the first known location and the second known location based at least in part on a time difference of arrival of the first ranging signal and the second ranging signal.

21. A computer program product for position location, comprising:
a non-transitory computer-readable medium having non-transitory program code recorded thereon, the program code comprising:
program code to receive, at an asset tag, a first ranging signal from a first known location;
program code to receive, at the asset tag, a second ranging signal that was transmitted from a device having a second known location a known delay after the first ranging signal was received at the device; and
program code to compute, at the asset tag, a pseudo-range between the asset tag and at least one of the first known location and the second known location based at least in part on a time difference of arrival of the first ranging signal and the second ranging signal.
